(19) United States
(12) Patent Application Publication
(10) Pub. No.: US 2003/0002102 A1
(43) Pub. Date: Jan. 2, 2003

(54) Device for frequency band demultiplexing

(76) Inventors: Sabry Khalfallah, Paris (FR); Ludovic Noirie, Nozay (FR); Denis Penninckx, Nozay (FR)

Correspondence Address: SUGHRUE MION, PLLC, 2100 PENNSYLVANIA AVENUE, N.W., WASHINGTON, DC, 20037, US

(21) Appl. No.: 10/181,268

(22) PCT Filed: Nov. 30, 2001
(86) PCT No.: PCT/FR01/03786

(30) Foreign Application Priority Data
Dec. 7, 2000 (FR) 00/15912

(51) Int. Cl. H04J 14/02; G02B 6/293

(52) U.S. Cl. 359/124; 385/24

(57) ABSTRACT

The invention relates to an optical demultiplexing system for separating frequency bands of a frequency-division multiplex, said system comprising a 1 to n first cyclic demultiplexer for demultiplexing said multiplex into n interleaved frequency combs each comprising m channels and a second cyclic demultiplexer for separating the channels of said n interleaved combs to obtain m consecutive bands comprising n consecutive frequencies, characterized in that said second multiplexer is an m to m cyclic demultiplexer having n input ports connected to respective output ports of said 1 to n first cyclic demultiplexer and in that the numbers n and m are mutually prime numbers.

The present invention relates to frequency-division multiplex optical fiber transmission systems. To be more precise, the invention relates to a system for demultiplexing bands of frequencies.

The present invention is in the field of optical telecommunications. Optical switches or timeslot interchange units are routinely used in this context and their complexity is increasing all the time.

In optical fiber systems transmission capacity increases with time. This increase is the result of an increase in the number of frequency-division multiplexed channels transmitted in each fiber and an increase in the number of fibers per cable. It gives rise to the problem of routing and cross-connecting channels in switching systems, to be more precise the problem of the increasing complexity of switching systems called upon to route an increasing number of channels.

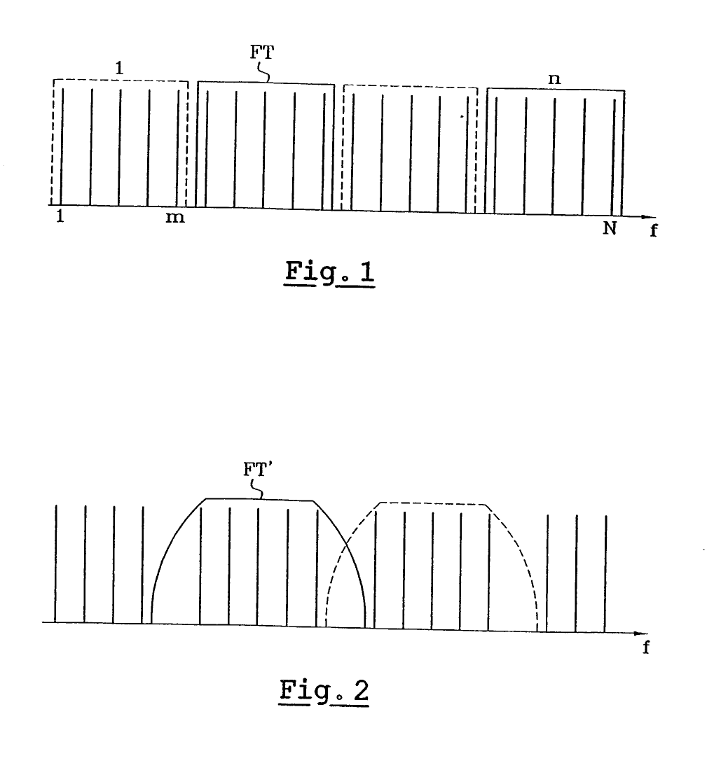

One solution to this problem is to group adjacent frequencies to form bands and to switch the resulting bands. This solution limits the number of frequency converters used in each optical timeslot interchange unit. The incoming multiplex, consisting of N frequencies or channels, is therefore divided into n consecutive bands each comprising m consecutive frequencies, as shown in FIG. 1.

The companies JDS Uniphase and E-Tek already offer products capable of multiplexing and demultiplexing a few bands of frequencies in ranges of frequency typically from 1 529 to 1 542 nanometers (blue band C) and from 1 547 to 1 605 nm (blue band L) or from 1 529 to 1 562 nm (band C) and from 1 574 to 1 605 nm (band L).

However, the systems marketed by JDS-Uniphase and E-Tek are not entirely satisfactory. In the systems mentioned above bands are demultiplexed by filtering. Filtering of the bands is therefore limited by the inherent characteristics of the components used.

FIG. 1 shows the spectral response FT of an ideal filter. The shape of the spectral response is perfectly rectangular with steep edges. This kind of spectral response produces a good rate of rejection between bands, indicative of the quality of filtering.

A good rejection rate is reflected in a pass-band to stop-band ratio close to unity. The pass-band corresponds to the whole of the spectrum that is passed without being attenuated by more than a particular number of decibels (dB) defined beforehand, for example 0.5 dB or 3 dB. The stop band corresponds to a spectral interval outside which the signal is attenuated by at least a particular number of decibels defined beforehand, typically 30 or 40 dB.

Frequencies between the pass-band and the stop-band cannot be used because they are too attenuated to be used on the band demultiplexer channel concerned and insufficiently attenuated to be used on other band demultiplexer channels. They are therefore “lost” frequencies.

In existing solutions to the problem of separating the bands, the components used are conventionally filters in the form of stacked thin layers, Mach-Zehnder interferometers or array waveguide gratings. FIG. 2 shows the spectral response FT′ of such components.

The rectangular filter characteristic is highly imperfect. To filter all the frequencies of the band in the same fashion, it is necessary for the frequencies to be within the flat part of the spectral response. This flat part of the spectral response must therefore be sufficiently wide. The edges of the spectral response FT′ are not steep, however. Consequently, the edges cross over at a particular level, as a result of which the extreme frequencies, those at the edges of the bands, in fact belong to two bands simultaneously. This feature, which is due to the non-ideal spectral response of the components employed to separate the bands, creates crosstalk. To prevent crosstalk and obtain a good rejection rate, it is necessary to provide gaps between the bands where the edges cross over. The frequencies at the edges of the band, normally taken into account in the context of ideal filtering, are lost and cannot be used.

Thus because these conventional filters are used in the prior art solutions, it is necessary to introduce discontinuities into the use of the frequency spectrum.

Accordingly, the problem that the invention aims to solve is that of optimally dividing a multiplex comprising N frequencies or channels into n consecutive bands each comprising m consecutive frequencies, in a manner that alleviates the drawbacks of the prior art, i.e. without introducing discontinuities into the frequency spectrum.

To this end, the invention proposes to create artificially the operating conditions of an ideal band filter like that shown in FIG. 1, by substituting a routing function for the filter function. The architecture in accordance with the invention therefore provides a succession for two cascaded stages in which the incoming frequency spectrum is first divided into a plurality of interleaved frequency combs or groups by a first cyclic de-interleaver demultiplexer for filtering the incoming spectrum, after which the frequency combs are processed in a second cyclic demultiplexer having a routing function, to obtain consecutive frequency bands with no discontinuity or crosstalk.

The system according to the invention is also adapted to operate as a frequency-division multiplex channel selector. The architecture of the system is then adapted for such operation, in particular by inserting a strip of optical amplifiers acting as switches between the two demultiplexer stages.

The invention therefore provides an optical demultiplexing system for separating frequency bands of a frequency-division multiplex, said system comprising a 1 to n first cyclic demultiplexer for demultiplexing said multiplex into n interleaved frequency combs each comprising m channels and a second cyclic demultiplexer for separating the channels of said n interleaved combs to obtain m consecutive bands comprising n consecutive frequencies, characterized in that said second multiplexer is an m to m cyclic demultiplexer having n input ports connected to respective output ports of said 1 to n first cyclic demultiplexer and in that the numbers n and are mutually prime numbers.

The invention also provides an interleaved band selector-demultiplexer adapted to select channels of a frequency-division multiplex (WDM), said selector-demultiplexer including a first cyclic demultiplexer for demultiplexing said multiplex into n interleaved frequency combs each comprising m channels and a second cyclic demultiplexer for separating the channels of said interleaved combs, characterized in that said second demultiplexer is an m to m cyclic demultiplexer having n input ports connected to respective output ports of said first demultiplexer via a first strip of optical switches, and in that the numbers n and m are mutually prime numbers.

Other features and advantages of the present invention will become more clearly apparent on reading the following description of one particular embodiment of the invention, which is given with reference to the accompanying drawings, in which:

FIG. 1 is a diagram showing the spectral response of an ideal band filter, and has already been described in the above preamble;

FIG. 2 is a diagram illustrating the real spectral response of the components used in prior art solutions to separate consecutive frequency bands, and has already been described in the above preamble;

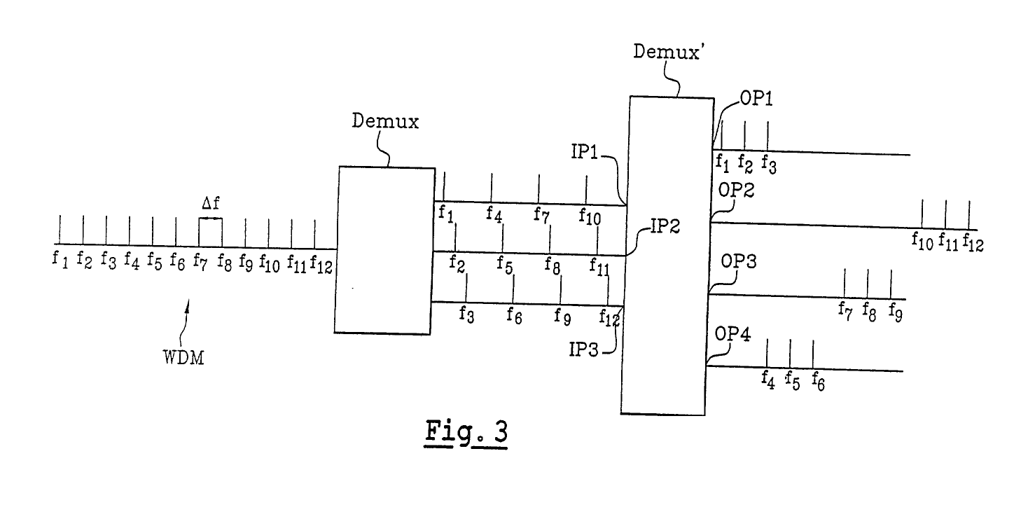

FIG. 3 is a diagram showing an optical demultiplexing system according to the present invention; and

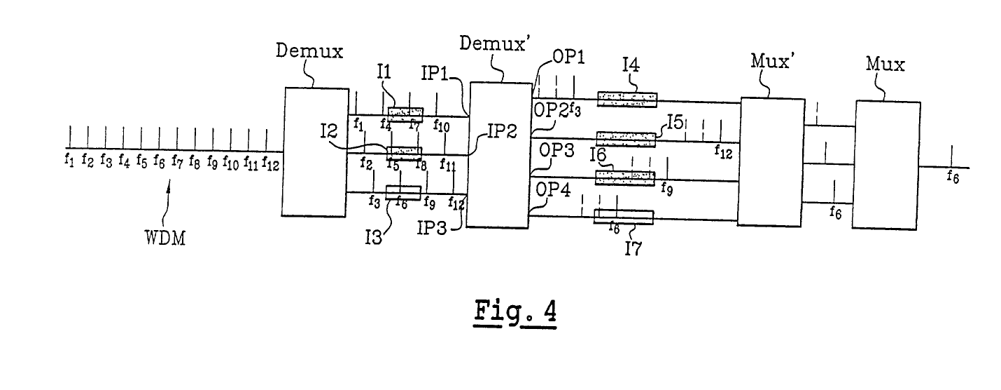

FIG. 4 is a diagram showing a frequency-division multiplex channel selector system according to the present invention.

FIG. 3 shows a preferred embodiment of a demultiplexing system according to the invention.

The frequency-distribution multiplex WDM comprises 12 frequencies or channels f1 to f12. The channels are separated from each other by a constant spectral frequency interval Δf. The multiplex is received at the single input of a cyclic deinterleaver demultiplexer Demux. Three interleaved frequency combs each of four channels are obtained at respective output ports of the deinterleaver demultiplexer Demux. The three interleaved combs are received at three consecutive input ports IP1, IP2 and IP3 of a second cyclic demultiplexer Demux′ which groups the frequencies at four output ports OP1, OP2, OP3 and OP4 to form four consecutive frequency bands each comprising three consecutive frequencies. The two components Demux and Demux′ are adapted to operate with the same channel spacing Δf.

The demultiplexer used to demultiplex the incoming multiplex WDM into three interleaved combs is a 1 to 3 deinterleaver demultiplexer. The deinterleaver demultiplexer Demux uses band filtering based on Mach-Zehnder filters (in the case of two bands), for example, on etched arrays, or on array waveguide gratings (AWG). The spectral response of these filters is periodic. In each period, a frequency of the multiplex is selected to constitute the frequency comb.

The multiplex WDM is therefore demultiplexed into three interleaved frequency combs each of four channels, i.e. the combs are formed of channels that are not adjacent. A channel of one comb is adjacent channels of other combs. Thus a first comb comprises frequencies f1, f4, f7 and f10, a second comb comprises frequencies f2, f5, f8 and f11, and finally a third comb comprises frequencies f3, f6, f9 and f12. The channels of the same comb are separated by a constant spectral interval corresponding to the number of interleaved frequency combs multiplied by the spectral interval Δf, that is to say 3×Δf.

The second stage of demultiplexing which produces the four consecutive bands each comprising three consecutive frequencies comprises a 4 to 4 cyclic demultiplexer Demux′ having three input ports IP1, IP2 and IP3 connected to respective output ports of the first cyclic demultiplexer Demux. An input port of the demultiplexer Demux′ that is not shown is therefore not used. The demultiplexer Demux′ can advantageously comprise an etched array or an array waveguide grating and operate as a router rather than as a filter. Its role is therefore to send a frequency from an input port to one of the output ports OP1 to OP4 in order to group the frequencies into blocks that correspond to the bands required.

Thus, in the system according to the invention, the first demultiplexer Demux is used as a deinterleaver demultiplexer and the second demultiplexer Demux′ is used as a router in that several input ports and several output ports are used. The combination of the functions of each of the two multiplexers used is equivalent to an ideal filter function.

The router Demux′ operates in accordance with the following principle.

Consider first of all the input port IP1. The frequency comb comprising frequencies f1, f4, f7 and f10 enters at this input port IP1. The router assigns the frequencies to the output ports in the order following their input order, given that it assigns them one by one for the output lines.

Thus frequency f1 is assigned to output port OP1. The frequency f4 is assigned to output port OP4.

Account must be taken of the cyclic operating mode of the demultiplexer used when assigning frequencies whose index is greater than the number of output ports of the demultiplexer Demux′, which is four in this example. The component Demux′ used as a router was designed to loop. Accordingly, let m denote the number of output ports of the demultiplexer Demux′. A frequency with index m+1 at the input port IP1 of Demux′ is assigned to output port OP1, a frequency with index m+2 at input port IP1 is assigned to output port OP2, and so on.

Thus the frequency f7 is assigned to output port OP3 and frequency f10 is assigned to output port OP2.

The above routing principle is then repeated for the next two input ports IP2 and IP3, given that when the input port concerned is shifted one step down, the output port assigned is shifted one step up, and if the input port is shifted two steps down, the output port assigned is shifted two steps up.

Accordingly, consider input port IP2. In accordance with the principle explained above, frequency f2 is assigned to output port OP1, frequency f5 is assigned to output port OP4, frequency f8 is assigned to output port OP3, and frequency f11 is assigned to output port OP2.

Finally, consider the input port IP3, which is shifted two steps down relative to input port IP1. Thus frequency f3 is assigned to output port OP1, frequency f6 is assigned to output port OP4, frequency f9 is assigned to output port OP3, and frequency f12 is assigned to output port OP2.

The system according to the invention therefore divides the incoming spectrum WDM into four consecutive bands each comprising three consecutive frequencies, the consecutive frequency bands being subject to no significant crosstalk. All of the incoming spectrum is used, with no discontinuity. An essential feature of correct operation of the system according to the invention is that the number of consecutive bands and the number of consecutive frequencies constituting each band are mutually prime numbers.

To generalize this, let N be the total number of frequencies in the incoming multiplex WDM. The demultiplexing system according to the invention divides the incoming spectrum into m consecutive bands of n consecutive frequencies using an architecture comprising two stages in cascade. The first stage uses a 1 to n cyclic deinterleaver demultiplexer Demux to demultiplex the incoming multiplex into n interlaced frequency combs and the second stage uses an m to m cyclic demultiplexer Demux′ as a router having n input ports connected to output ports of the 1 to n first demultiplexer.

The numbers n and m must be mutually prime for the system to operate correctly and obtain the required arrangement of frequencies shown in FIG. 3. If this condition is not satisfied, it is then necessary to use in the second routing stage a p to p router demultiplexer, where p is greater than m and p and n are mutually prime numbers. In this case, (p−m) output ports are not used.

The system according to the invention is also adapted to operate as a frequency-division multiplex channel selector. FIG. 4 shows one example of this particular mode of operation of the system according to the invention for a number of channels equal to 12.

The system shown in FIG. 4 differs from that shown in FIG. 3 in that two additional stages in cascade are provided at the output of the router demultiplexer Demux′.

A third stage comprises a 4 to 4 cyclic multiplexer Mux′ used as a router and a fourth stage comprises a 3 to 1 cyclic multiplexer Mux. All the components of the selector system according to the invention (Demux, Demux′, Mux′ and Mux) are adapted to operate with the same channel spacing Δf.

What is more, a first strip comprising three optical switches (for example optical amplifiers) 11, 12 and 13 is inserted between the cyclic deinterleaver demultiplexer Demux and the router demultiplexer Demux′.

A second strip comprising four switches 14, 15, 16 and 17 is inserted between the router demultiplexer Demux′ and the router multiplexer Mux′. The frequencies shown in dashed line are frequencies that have been eliminated.

In the same fashion as previously, the incoming multiplex WDM comprising twelve frequencies f1 to f12 is demultiplexed into three interleaved frequency combs of four channels each by the 1 to 3 demultiplexer Demux.

In the FIG. 4 example, the switch 13 of the first strip is closed and the other two amplifiers 11 and 12 are open. Accordingly, only the frequency comb comprising the frequencies f3, f6, f9 and f12 is selected for processing by the 4 to 4 router demultiplexer Demux′. In accordance with the principle already described with reference to FIG. 3, and thanks to the cyclic nature of the demultiplexer Demux′, each of the four channels f3, f6, f9 and f12 of the selected comb is sent to a respective output port of Demux′. Accordingly, frequency f3 is sent to output port OP1, frequency f6 is sent to output port OP4, frequency f9 is sent to output port OP3, and frequency f12 is sent to output port OP2. Because the switches 11 and 12 are open, the other frequencies are eliminated.

Of the switches of the strip inserted between the second and third stages of the system according to the invention, only the switch 17 is closed, the switches 14, 15 and 16 being open. Accordingly, frequency f6 is selected by switch 17 and frequencies f3, f9 and f12 are eliminated.

The combination of the 4 to 4 router multiplexer Mux′ and the 3 to 1 cyclic multiplexer Mux is then used to recover the selected object, in this instance the frequency f6, at a single output port OF of the system.

The FIG. 4 system can also be used as a band selector. In this case, the three switches of the first strip are closed and the three interleaved frequency combs are selected. The first half of the selector system shown in FIG. 2 then operates in the same fashion as the band demultiplexing system shown in FIG. 3. Four consecutive bands each of three consecutive frequencies are therefore obtained at the output of the router demultiplexer Demux′. Closing a single one of the four switches 14, 15, 16 or 17 of the second strip selects a single band of frequencies. The router multiplexer Mux′ then sends the three frequencies corresponding to the selected band to three consecutive output ports and the 3 to 1 cyclic multiplexer Mux groups the three frequencies, so recovering the selected band at the single output port OF.

Finally, the FIG. 4 system can be used as an interleaved comb selector. In this case only one of the three switches 11, 12, 13 of the first strip is closed. A single comb of four interleaved frequencies is then selected. If the four switches 14, 15, 16 and 17 of the second strip are closed, the four frequencies of the selected comb are sent to the four output ports of the 4 to 4 router multiplexer Mux′ and a 4 to 1 cyclic multiplexer groups them to recover the selected comb at the single output port OF.

The FIG. 4 system therefore has three functions. A first function is frequency selection. For this it is necessary to turn on two switches, one in each strip.

A second function selects an interleaved comb by turning on a single switch in the first strip and all the switches in the second strip. Finally, a third function selects a band of consecutive frequencies by turning on all the switches of the first strip and only one switch of the second strip. Regardless of the object that is selected, it is always recovered at the same output port OF.

As for FIG. 3, this can be generalized by taking N as the total number of frequencies of the incoming multiplex WDM. The frequency selector according to the invention uses an architecture comprising four cascaded stages. The first stage uses a 1 to n cyclic demultiplexer Demux to demultiplex the incoming multiplex into n interleaved frequency combs each of m frequencies (N=n×m).

The second stage uses an m to m cyclic demultiplexer Demux′ as a router having n input ports connected to the output ports of the first demultiplexer Demux′ by a first strip comprising n optical switches. The numbers n and m must be mutually prime numbers.

The third stage uses an m to m cyclic multiplexer Mux′ which is also used as a router and whose input ports are connected to respective output ports of the demultiplexer Demux′ via a second switch comprising m optical switches.

Finally, the multiplexer Mux′ is cascaded with a final stage using an n to 1 cyclic multiplexer Mux to recover the selected channel or channels at the single output port OF.

1. An optical demultiplexing system for separating frequency bands of a frequency-division multiplex (WDM), said system comprising a 1 to n first cyclic demultiplexer (Demux) for demultiplexing said multiplex (WDM) into n interleaved frequency combs each comprising m channels and a second cyclic demultiplexer (Demux′) for separating the channels of said n interleaved combs to obtain m consecutive bands comprising n consecutive frequencies, characterized in that said second multiplexer (Demux′) is an m to m cyclic demultiplexer having n input ports connected to respective output ports of said 1 to n first cyclic demultiplexer (Demux) and in that the numbers n and m are mutually prime numbers.

2. A system according to claim 1, characterized in that the 1 to n first demultiplexer (Demux) is a deinterleaver demultiplexer using filtering with a periodic spectral response.

3. A system according to claim 2, characterized in that interleaved combs are filtered by Mach-Zehnder or waveguide array grating filters.

4. A system according to claim 1, characterized in that the m to m second demultiplexer (Demux′) is an etched array or a waveguide array grating.

5. A system according to any preceding claim, characterized in that both demultiplexers (Demux, Demux′) are adapted to operate with the same channel spacing (Δf).

6. An interleaved band selector-demultiplexer adapted to select channels of a frequency-division multiplex (WDM), said selector-demultiplexer including a first cyclic demultiplexer (Demux) for demultiplexing said multiplex (WDM) into n interleaved frequency combs each comprising m channels and a second cyclic demultiplexer (Demux′) for separating the channels of said interleaved combs, characterized in that said second demultiplexer (Demux′) is an m to m cyclic demultiplexer having n input ports connected to respective output ports of said first demultiplexer (Demux) via a first strip of optical switches (l1, l2, l3), and in that the numbers n and m are mutually prime numbers.

7. A frequency selector according to claim 6, characterized in that it further comprises an m to m first cyclic multiplexer (Mux′) whose input ports are connected to respective output ports of the m to m second cyclic demultiplexer (Demux′) via a second strip of optical switches (l4, l5, l6, l7), said m to m cyclic multiplexer (Mux′) being cascaded with an n to 1 second cyclic multiplexer (Mux) to recover the selected channel or channels at a single output port (OF).
